(19) United States
(12) Patent Application Publication
(10) Pub. No.: US 2025/0137204 A1
(43) Pub. Date: May 1, 2025

(54) METHOD AND SYSTEM FOR FORMING A RECEPTACLE

(71) Applicant: Pulpex Limited, Sawston (GB)

(72) Inventors: Adam Richard TURNER, Croydon (GB); Jonathan Philip MORRIS, Cambridge (GB)

(21) Appl. No.: 19/004,102

(22) Filed: Dec. 27, 2024

Related U.S. Application Data
(63) Continuation of application No. PCT/GB2023/051691, filed on Jun. 29, 2023.

(30) Foreign Application Priority Data
Jul. 4, 2022 (GB) 2209797.6

(51) Int. Cl. D21J 5/00

(52) U.S. Cl. CPC D21J 5/00

(57) ABSTRACT

A receptacle moulding system for moulding a receptacle from a fibre suspension and a method for manufacturing a moulded receptacle, in which fibre suspension is deposited into a cavity of a mould during two deposition periods that are separated by an intervening pressure build-up period. During the pressure build-up period a negative pressure of increasing magnitude is generated within the cavity of the mould.

### CROSS-REFERENCE TO RELATED APPLICATIONS

This application is a continuation under 35 U.S.C. § 120 of International Application No. PCT/GB2023/051691, filed Jun. 29, 2023, which claims priority to United Kingdom Application No. GB 2209797.6, filed Jul. 4, 2022, under 35 U.S.C. § 119 (a). Each of the above-referenced patent applications is incorporated by reference in its entirety.

### TECHNICAL FIELD

The present invention relates to methods and systems for forming moulded receptacles from a fibre suspension, such as a fibre suspension comprising paper pulp. The receptacles may form consumer packaging, such as bottles, useful for holding liquids, powders, other flowable materials or solid objects.

### BACKGROUND

It is desirable to reduce plastics use in consumable items, particularly packaging. Trays and other simple shapes are commonly made from a fibre suspension, such as, in particular, a fibre suspension comprising paper pulp. However, more complex objects, such as bottles, are more difficult to engineer.

In certain existing methods for manufacturing objects from fibre suspension(s), such as a fibre suspension comprising paper pulp, an object is formed by introducing fibre suspension into a mould, so as to form a fibre-containing layer within the mould. In such manufacturing methods, a particular challenge is to achieve relatively even and complete coverage of the mould by the fibre-containing layer. Incomplete coverage can, for example, lead to the final object being misshapen or containing voids, whereas uneven coverage can, for example, lead to the final object having weak points that are more prone to rupture or breakage during use of the object.

### SUMMARY

To mitigate the issues identified above with achieving a relatively even and/or complete coverage of a mould by a fibre-containing layer, and/or to mitigate other issues connected with the formation of moulded receptacles from a fibre suspension, the inventors propose to deposit fibre suspension during two deposition periods that are separated by an intervening pressure build-up period. During this pressure build-up period, a negative pressure of increasing magnitude is generated within the cavity of the mould. This encourages the fibre suspension that is deposited during the second deposition period to accumulate at locations within the cavity where less of (or none of) the fibre suspension deposited during the first deposition period is present. Consequently, the overall effect of the two depositing periods is to provide a fibre-containing layer with relatively even and complete coverage of the mould.

Therefore, according to a first aspect of the present invention, there is provided a receptacle moulding system for moulding a receptacle from a fibre suspension, the system comprising: a mould comprising one or more internal surfaces that define a cavity, and a plurality of passageways that provide fluid communication between the cavity and an exterior of the mould; a fibre suspension supply system; a negative pressure source, configured to apply negative pressure to the exterior of the mould; and a control system, configured to control the fibre suspension supply system and the negative pressure source such that: during a first deposition period, a first volume of a first fibre suspension is deposited by the fibre suspension supply system within the cavity of the mould; during a second deposition period, a second volume of a second fibre suspension is deposited by the fibre suspension supply system within the cavity of the mould, while the negative pressure source applies negative pressure to the exterior of the mould; and during a pressure build-up period, which is after the first deposition period and before the second deposition period, the negative pressure source applies negative pressure to the exterior of the mould, while the fibre suspension supply system restricts deposition of the first and second fibre suspensions within the cavity, thereby generating a negative pressure of increasing magnitude within the cavity.

Because a negative pressure of increasing magnitude is generated within the cavity during the pressure build-up period, when the second volume of second fibre suspension is then deposited, the second fibre suspension may preferentially accumulate at locations within the cavity where less of (or none of) the first fibre suspension is present. Consequently, the thus-deposited second volume of the second fibre suspension in combination with the first volume of the first fibre suspension may together provide a deposited fibre layer that better covers the internal surfaces defining the cavity and/or has a relatively uniform thickness.

In some examples, the negative pressures applied by the negative pressure source and generated within the cavity may be negative gas pressures. For example, the negative pressures may be negative air pressures, particularly where the mould is in air during the first and second deposition periods and the pressure build-up period.

Optionally, the mould is porous, with the passageways being provided at least in part by a plurality of pores in the mould.

Optionally, the pressure build-up period immediately follows the first deposition period and/or immediately precedes the second deposition period.

In some examples, the system is configured so that, as a result of the negative pressure source applying negative pressure to the exterior of the mould during the depositing of the second volume of the second fibre suspension, turbulent flow of the second volume of the second fibre suspension occurs within the cavity. Without wishing to be bound by the theory, it is thought that that turbulent flow may distribute fibres particularly effectively, which may in turn lead to the deposition of a layer of fibres with relatively even thickness.

In some examples, the system further comprises a pressure sensor configured to measure pressure at the mould (for example at the exterior surface thereof, or within the cavity), and the control system is configured to cause the depositing of the second volume of the second fibre suspension, by the fibre suspension supply system, once an pressure value, as measured by the pressure sensor, falls below a predetermined negative threshold value. The pressure measured at the mould is considered a particularly suitable trigger for the depositing of the second volume of the second fibre suspension, as it may indicate that the second volume of the second fibre suspension will be drawn with appropriate force into the cavity. This may, in consequence, increase the likelihood that an even layer of fibre is formed within the cavity. Alternatively, or additionally, the depositing of the second volume of the second fibre suspension occurs once negative pressure has been applied to the exterior of the mould for a predetermined period of time during the pressure build-up period.

In some examples, the control system is configured to control the fibre suspension supply system such that, throughout the pressure build-up period, no deposition of any fibre suspension takes place in the cavity.

In some examples, the control system is configured to control the fibre suspension supply system such that: during the first deposition period, the first fibre suspension is introduced into the cavity at a first rate and, during the second deposition period, the second fibre suspension is introduced into the cavity at a second rate; and during the pressure build-up period, the fibre suspension supply system restricts deposition of the first and second fibre suspensions within the cavity such that a rate of introduction of fibre suspension into the cavity is less than the first rate and/or less than the second rate. The rate of introduction of fibre suspension during the pressure build-up period (e.g. the average or maximum rate) may be relatively low, such as, for example: less than 20% of the first rate (e.g. the maximum value thereof) and/or less than 20% of the second rate (e.g. the maximum value thereof); or, less than 10% of the first rate (e.g. the maximum value thereof) and/or less than 10% of the second rate (e.g. the maximum value thereof). While the rate of introduction of fibre suspension during the pressure build-up period may be relatively low, it may, in some examples, be greater than zero, so that at least some deposition of fibre suspension occurs during the pressure build-up period.

In some examples, the depositing of the first volume of the first fibre suspension leads to the formation of a first fibre-containing layer on the internal surfaces defining the cavity, and the depositing of the second volume of the second fibre suspension leads to the formation of a second fibre-containing layer on the internal surfaces defining the cavity, wherein the second layer at least partially covers the first layer. Optionally, the second layer covers the majority of, or the entirety of the first layer. Additionally, or alternatively, the first layer covers the majority of, or the entirety of the internal surfaces that define the cavity.

Optionally, the control system is configured to control the fibre suspension supply system and the negative pressure source such that, during the depositing of the first volume of the fibre suspension, negative pressure is applied to the exterior of the mould.

In some examples, the control system is configured to control the negative pressure source such that, throughout a formation period, which comprises the first deposition period, the second deposition period and the pressure build-up period, the negative pressure source applies negative pressure to the exterior of the mould. Optionally, the control system is configured to control the negative pressure source such that, throughout the formation period, the negative pressure source applies a constant negative pressure to the exterior of the mould.

According to a second aspect of the present invention, there is provided a method for manufacturing a moulded receptacle, the method comprising: during a first deposition period, depositing a first volume of a first fibre suspension within a cavity of a mould, the mould comprising one or more internal surfaces that define the cavity, and a plurality of passageways that provide fluid communication between the cavity and an exterior of the mould; during a second deposition period, depositing a second volume of a second fibre suspension within the cavity of the mould, while applying negative pressure to the exterior of the mould; and during a pressure build-up period, which is after the first deposition period and before the second deposition period, applying negative pressure to the exterior of the mould, while restricting deposition of the first and second fibre suspensions within the cavity, thereby generating a negative pressure of increasing magnitude within the cavity.

Because a negative pressure of increasing magnitude is generated within the cavity during the pressure build-up period, when the second volume of second fibre suspension is then deposited, the second fibre suspension may preferentially accumulate at locations within the cavity where less of (or none of) the first fibre suspension is present. Consequently, a deposited fibre layer that better covers the internal surfaces defining the cavity and/or has a relatively uniform thickness may be provided by the thus-deposited second volume of the second fibre suspension in combination with the first volume of the first fibre suspension.

Optionally, the mould is porous, with the passageways being provided at least in part by a plurality of pores in the mould.

Optionally, the pressure build-up period immediately follows the first deposition period and/or immediately precedes the second deposition period.

Optionally, the applying of negative pressure to the exterior of the mould during the depositing of the second volume of the second fibre suspension causes turbulent flow of the second volume of the second fibre suspension. Without wishing to be bound by the theory, it is thought that that turbulent flow may distribute fibres particularly effectively, which may in turn lead to the deposition of a layer of fibres with relatively even thickness.

Optionally, the depositing of the second volume of the second fibre suspension occurs once an pressure value, as measured at the mould (for example at the exterior surface thereof, or within the cavity), falls below a predetermined negative threshold value. The measured pressure at the mould is considered a particularly suitable trigger for the depositing of the second volume of the second fibre suspension, as it may indicate that the second volume of the second fibre suspension will be drawn with appropriate force into the cavity. This may, in consequence, increase the likelihood that an even layer of fibre is formed within the cavity. Alternatively, or additionally, the depositing of the second volume of the second fibre suspension occurs once negative pressure has been applied to the exterior of the mould for a predetermined period of time during the pressure build-up period.

In some examples, throughout the pressure build-up period, no deposition of any fibre suspension takes place within the cavity.

Optionally, during the first deposition period, the first fibre suspension is introduced into the cavity at a first rate and, during the second deposition period, the second fibre suspension is introduced into the cavity at a second rate, and, during the pressure build-up period, the restricting of deposition of the first and second fibre suspensions within the cavity results in a rate of introduction of fibre suspension into the cavity that is less than the first rate and/or less than the second rate. The rate of introduction of fibre suspension during the pressure build-up period may be relatively low, such as, for example: less than 20% of the first rate and/or less than 20% of the second rate; or, less than 10% of the first rate and/or less than 10% of the second rate. While the rate of introduction of fibre suspension during the pressure build-up period may relatively low, it may, in some examples, be greater than zero, so that at least some deposition of fibre suspension occurs during the pressure build-up period.

In some examples, the depositing of the first volume of the first fibre suspension leads to the formation of a first fibre-containing layer on the internal surfaces defining the cavity, and the depositing of the second volume of the second fibre suspension leads to the formation of a second fibre-containing layer on the internal surfaces defining the cavity, wherein the second layer at least partially covers the first layer. Optionally, the second layer covers the majority of, or the entirety of the first layer. Additionally, or alternatively, the first layer covers the majority of, or the entirety of the internal surfaces that define the cavity.

In some examples, the method further comprises, during the depositing of the first volume of the first fibre suspension, applying negative pressure to the exterior of the mould.

In some examples, the method comprises applying negative pressure to the exterior of the mould throughout a formation period, which comprises the first deposition period, the second deposition period and the pressure build-up period. Optionally, the method comprises applying a constant negative pressure to the exterior of the mould throughout the formation period.

In some examples of the systems and methods above, the first fibre suspension is substantially the same as the second fibre suspension.

However, in other examples, the first fibre suspension may be different than the second fibre suspension. In particular, in such examples, an average fibre length of the first fibre suspension may be different than an average fibre length of the second fibre suspension. Optionally, the average fibre length of the first fibre suspension is less than the average fibre length of the second fibre suspension. Without wishing to be bound by the theory, it is thought that that the characteristic average fibre length of a fibre suspension may impact the smoothness of the deposited layer of fibres. Suitable selection of the average fibre length for the first and second fibre suspensions may therefore assist in providing a fibre layer with appropriate characteristics. As an example, a smaller average fibre length for the first fibre suspension may provide a receptacle with a relatively smooth exterior surface. Alternatively, or in addition, a freeness of the first fibre suspension may be different than a freeness of the second fibre suspension. Optionally, the freeness of the first fibre suspension is greater than the freeness of the second fibre suspension. Without wishing to be bound by the theory, it is thought that that the freeness of a fibre suspension may impact how evenly fibres are distributed within the cavity. Suitable selection of the freeness for the first and second fibre suspensions may therefore assist in providing a fibre layer with appropriate characteristics. As an example, a higher freeness may allow the first volume of the first fibre suspension to achieve a relatively even initial distribution of fibres within the cavity.

In some examples of the systems and methods above, the receptacle is a bottle.

According to a third aspect of the present invention there is provided a receptacle obtainable or obtained from a fabrication method comprising any of the above methods for manufacturing a moulded receptacle. For example, the receptacle may be obtainable or obtained from any of the above methods. The fabrication method may comprise at least one additional process. The at least one additional process may comprise further moulding the receptacle to produce a further-moulded receptacle. The at least one additional process may comprise coating and drying the receptacle or the further-moulded receptacle to produce a coated receptacle. The at least one additional process may comprise applying a closure to the receptacle, the further-moulded receptacle or the coated receptacle. In some examples, the receptacle is a bottle.

### BRIEF DESCRIPTION OF DRAWINGS

Embodiments of the invention will now be described, by way of example only, with reference to the accompanying drawings, in which:

FIG. 1 is a schematic view of an example process for making bottles from paper pulp;

FIG. 2 is a schematic diagram of a receptacle moulding system according to an example embodiment of the invention;

FIG. 3 is a schematic diagram that illustrates the operation of the receptacle moulding system shown in FIG. 2 to mould a receptacle;

FIGS. 4A-4C are schematic diagrams showing the mould of the moulding system of FIG. 2 at respective points in time during the moulding operation of FIG. 3;

FIG. 5 is a schematic diagram of a fibre suspension supply system that forms part of a receptacle moulding system according to a further example embodiment;

FIG. 6 is a flow diagram illustrating a method for manufacturing a moulded receptacle according to a further aspect of the invention; and

FIG. 7 is a side view of a receptacle according to a still further aspect of the invention in assembled and disassembled states.

### DETAILED DESCRIPTION

The following description presents exemplary embodiments and, together with the drawings, serves to explain principles of embodiments of the invention.

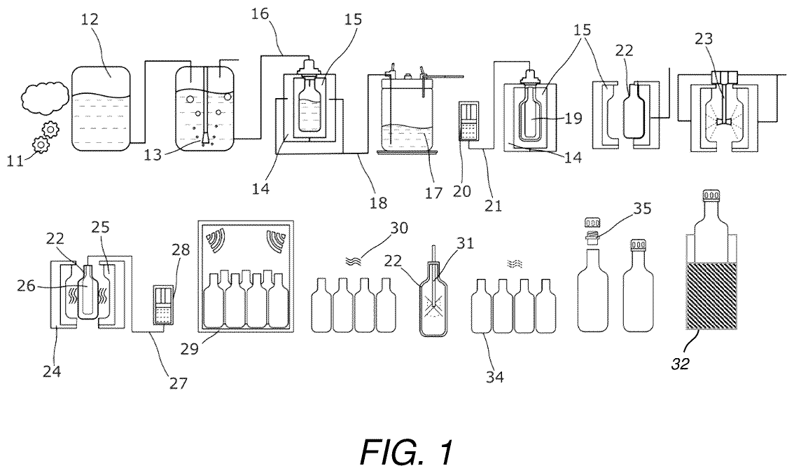

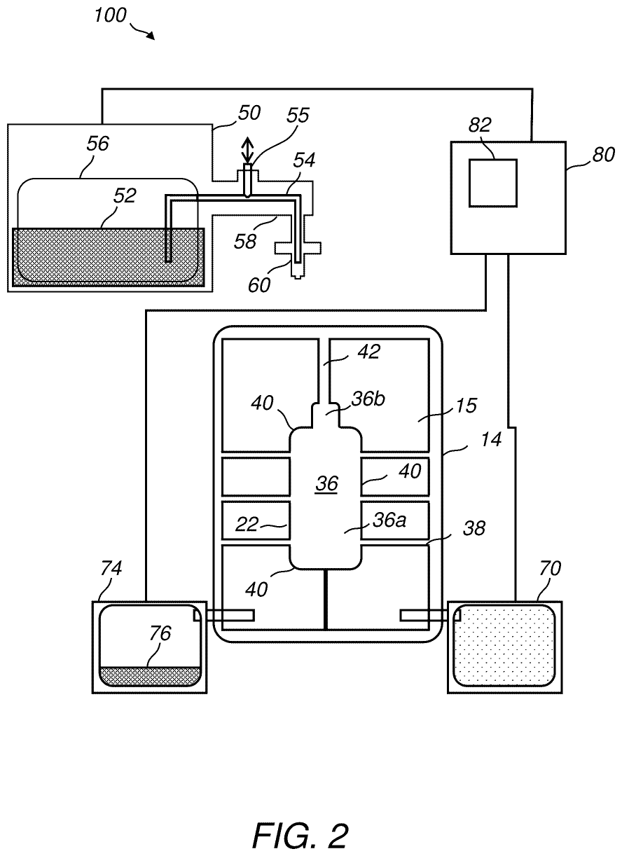

FIG. 1 shows a process for making bottles from paper pulp (i.e., which can form the basis of an example fibre suspension). The process is merely exemplary and is provided to give context to examples of the present invention, such as those described below with reference to FIGS. 2-6.

Broadly speaking, the exemplary process comprises providing a fibre suspension, introducing the fibre suspension into a mould cavity of a porous first mould and using the porous first mould to expel a liquid (such as water) from the fibre suspension to produce a wet precursor or embryo (which may itself be considered a moulded receptacle), further moulding the wet precursor in a mould to produce a further-moulded receptacle, coating the further-moulded receptacle to produce a coated moulded receptacle, drying the coated moulded receptacle to produce a dried receptacle, and applying a closure to the dried receptacle. As will be apparent at least from the following description, modifications may be made to the exemplary process to provide variants thereof in which other examples of the present invention may be embodied.

In this example, providing the fibre suspension comprises preparing the fibre suspension from ingredients thereof. More specifically, the preparing comprises providing pulp fibres, such as paper pulp fibres, and mixing the pulp fibres with a liquid to provide hydrated pulp fibres. In this example, the pulp fibres are provided in sheet form from a supplier and the liquid comprises water and one or more additives. In this example, the liquid is mixed with the pulp fibres to provide hydrated pulp fibres having a solid fibres content of 1 wt % to 5 wt % (by dry mass of fibres). In examples, the one or more additives includes a sizing agent, such as alkylketene dimer (AKD). The hydrated pulp fibres typically comprise AKD in an amount of 0.4 wt % with respect to the total dry mass of the solid fibres in the hydrated pulp fibres. In some examples, one or more additives are present in the liquid at the point of mixing the pulp fibres with the liquid. In some examples, one or more additives are included in the hydrated pulp fibres after mixing the pulp fibres with the liquid (e.g. the pulp fibres are hydrated for a period of time, such as from 2 to 16 hours, and then one or more additives are supplied to the hydrated pulp fibres). The hydrated pulp fibres are passed between plates of a valley beater 11 or refiner that are in motion relative to each other. This fibrillates some, or all, of the fibres, meaning that cell walls of those fibres are caused to become partially delaminated so that wetted surfaces of those fibres comprise protruding hairs or fibrillations. These fibrillations will help to increase a strength of bonds between the fibres in the dried end product. In other examples, the valley beater 11 or refiner may be omitted.

The resultant processed pulp is stored in a vat 12 in a relatively concentrated form (e.g. a solid fibres content of 1 wt % to 5 wt %) to reduce a required storage space. At an appropriate time, the processed pulp is transferred to a mixing station 13 at which the processed pulp is diluted in further water and, optionally, mixed with one or more additives (as well as, or in place of, the one or more additives provided with the hydrated pulp fibres) to provide the fibre suspension ready for moulding. In this example, the solid fibres account for 0.7 wt % of the resultant fibre suspension (by dry weight of fibres), but in other examples the proportion of solid fibres in the fibre suspension may be different, such as another value in the range of 0.5 wt % to 5 wt %, or 0.1 wt % to 1 wt %, of the fibre suspension (by dry weight of fibres). In some examples, the one or more additives mixed with the processed pulp and water includes a dewatering agent, such as modified and/or unmodified polyethylene imine (PEI), e.g. modified PEI sold under the trade name Polymin® SK. In some examples, the one or more additives are mixed with the water, and the water and one or more additives subsequently mixed with the processed pulp; in other examples, the processed pulp and water are mixed, and the one or more additives subsequently mixed with the processed pulp and water. The fibre suspension typically comprises Polymin® SK in an amount of 0.3 wt % with respect to the total dry mass of the solid fibres. Mixing of the fibre suspension at the mixing station 13 helps to homogenise the fibre suspension. In other examples, the processed pulp or the fibre suspension may be provided in other ways, such as being supplied ready-made.

In this example, the porous first mould 15 comprises two half-moulds that are movable towards and away from each other, in this case using a hydraulic ram. In this example, each of the half-moulds is a monolithic or unitary tool formed by additive manufacturing (e.g. 3D-printing) that defines a mould profile, and, when the half-moulds are brought into contact with each other, their respective mould profiles cooperate to define the mould cavity in which the wet precursor or moulded receptacle is to be formed. Each half-mould may itself define a smaller moulding cavity and, when brought into cooperation with a second half-mould, the smaller moulding cavities may combine to provide the overall mould cavity. The two half-moulds may themselves be considered “splits” or “moulds” and the overall porous first mould 15 may be considered a “split-mould” or, again, a “mould”. In other examples, the porous first mould 15 may comprise more than two splits, such as three, four or six splits, that cooperate to define the moulding cavity.

In FIG. 1, the fibre suspension (also known as slurry) is top-filled into the porous mould 15, in contrast to moulding processes that dip a mould in slurry. The fibre suspension is drawn under vacuum via a line 16 and into the porous mould 15, with excess suspending liquid being drawn through the porous mould 15 under vacuum via a line 18 into a tank 17. Shot mass may be controlled by measuring (e.g., weighing) the amount of liquid drawn into the tank 17. A weight scale platform supporting the tank 17 is visible in FIG. 1. Once a required amount (e.g. a predetermined volume, such as 10 litres, or a predetermined mass, such as 10 kilograms) of liquid has been collected in the tank 17, suction of the suspending liquid through the porous mould 15 is stopped and the porous mould 15 is opened to ambient air. In this example, the suspending liquid drawn with the fibre suspension in line 16 is water, or predominantly water (as additives may also be present). The liquid drawn under vacuum via the line 18 and into the tank 17 is substantially free of fibres, since these are left behind against the walls of the porous mould 15 to form an embryo of the moulded receptacle.

In one form, in order to remove further suspending liquid (e.g. water) from the embryo, and form or consolidate the three-dimensional shape of the receptacle, an impermeable inflation element 19, e.g., a collapsible bladder, is inserted into the porous mould 15 and expanded to act as an internal high-pressure core structure for the porous mould 15. This process strengthens the wet embryo so that it can be handled, and displaces water from in between the fibres, thereby increasing the efficiency of a subsequent drying process. The inflation element 19 is actuated and regulated using a hydraulic pump 20. The pump 20 has a cylinder that displaces a fluid in a line 21 into the inflation element 19, to expand the inflation element 19 radially and into conformity with the mould cavity. Fluid within the line 21 is preferably non-compressible, such as water. Water also has the advantage over other non-compressible liquids that any leaking or bursting of the bladder 19 will not introduce a new substance to the system (since the suspending liquid is already water, or predominantly water).

Demoulding occurs when the porous mould 15 opens for removal of the self-supporting moulded receptacle 22. Mould cleaning 23 is preferably performed subsequently, to remove small fibres and maintain a porosity of the porous mould 15. In this example, a radially firing high-pressure jet is inserted into the mould cavity while the mould 15 is open. This dislodges fibres from the wall of the mould cavity. Alternatively, or in addition, water from the tank 17 is pressurised through the back of the porous mould 15 to dislodge entrapped fibres. Water is drained for recycling back to an upstream part of the system. It is noteworthy that cleaning is important for conditioning the porous mould 15 for re-use. The porous mould 15 may appear visibly clean after removal of the receptacle, but its performance could be compromised without cleaning.

According to FIG. 1, the formed but unfinished receptacle 22 is subsequently transported to a second moulding station where, in a, e.g., aluminium, mould 25, pressure and heat are applied for thermoforming a desired neck and surface finish, optionally including embossed and/or debossed surface features. After two halves of the mould 25 have closed around the receptacle 22, a pressuriser is engaged. For example, a bladder 26 (e.g., a thermoforming bladder 26) is inserted into the receptacle 22. The bladder 26 is inflated via a line 27 by a pump 28 to supply pressurised fluid, e.g., air, water, or oil. Optionally, during supply, the pressurised fluid is heated with e.g. a heater or, alternatively, is cooled with e.g. a heat exchanger. An external mould block 24 of the mould 25, and/or the mould 25 itself, may also, or alternatively, be heated. A state of the moulded receptacle 22 after thermoforming is considerably more rigid, with more compressed side walls, compared with the state at demoulding from the porous mould 15.

A drying stage 29 (e.g. a microwave drying process or other drying process) is performed downstream of the thermoforming, as shown. In one example, the drying stage 29 is performed before thermoforming. However, moulding in the mould 25 requires some water content to assist with bonding during the compression process. FIG. 1 illustrates a further drying stage 30 after the drying stage 29, which may utilise hot air circulated onto the moulded receptacle 22, e.g., in a “hot box”. In some examples, microwave or other drying processes may be performed at plural stages of the overall manufacturing process.

The moulded receptacle 22 is then subjected to a coating stage during which, in this example, a spray lance 31 is inserted into the moulded receptacle 22 and applies one or more surface coatings to internal walls of the moulded receptacle 22. In another example, the moulded receptacle 22 is instead filled with a liquid that coats the internal walls of the moulded receptacle 22. In practice, such coatings provide a protective layer to prevent egress of contents into the bottle wall, which may permeate and/or weaken it. Coatings will be selected dependent on the intended contents of receptacle 22, e.g., a beverage, detergent, pharmaceutical product, etc. In some examples, the further drying stage 30 is performed after the coating stage (or both before and after the coating stage). In this example, the moulded receptacle 22 is then subjected to a curing process 34, which can be configured or optimised dependent on the coating, e.g., drying for twenty-four hours at ambient conditions or by a flash drying method. In some examples, e.g. where the further drying stage 30 occurs after the coating stage, the curing process 34 may be omitted.

At an appropriate stage of production (e.g., during thermoforming, or before or after coating) a closure or mouth forming process may be performed on the moulded receptacle 22. For example, as shown in FIG. 1, a neck fitment 35 may be affixed. In some examples, an exterior coating is applied to the moulded receptacle 22, as shown in the further coating stage 32. In one example, the moulded receptacle 22 is dipped into a liquid that coats its outer surface, as shown in FIG. 1. One or more further drying or curing processes may then be performed. For example, the moulded receptacle 22 may be allowed to dry in warm air. The moulded receptacle 22 may therefore be fully formed and ready to accept contents therein.

Reference is now directed to FIG. 2, which is a schematic diagram of a receptacle moulding system 100 according to an example embodiment of the invention. The system 100 is configured for moulding a receptacle 22 from a fibre suspension. The receptacle and/or the fibre suspension may, for example, be as described above with reference to FIG. 1. In this example, the receptacle 22 is a bottle.

As shown in FIG. 2, the system 100 comprises a mould 15, a fibre suspension supply system 50, a negative pressure source 70, and a control system 80. The control system 80 governs the operation of the receptacle moulding system 100 and, in particular, controls the fibre suspension supply system 50 and the negative pressure source 70. To facilitate such control, the control system 80 may be in data or signal communication with the fibre suspension supply system 50 and the negative pressure source 70, as is indicated in FIG. 2 by the lines extending from control system 80. As also shown in FIG. 2, the control system 80 may, in some examples, comprise at least one processor 82, which is suitably programmed to govern the operation of receptacle moulding system 100, for instance based on signals and/or data received from the fibre suspension supply system 50 and the negative pressure source 70.

Although, for the sake of simplicity, the control system 80 is illustrated with a single box in FIG. 2 it should be understood that the control system 80 need not be physically or functionally unitary. In particular, components of the control system 80 need not be co-located. Hence, in some embodiments, some or all of the components of the control system 80 may be integrated within other (sub) systems within the overall moulding system 100. Additionally, it is not essential that processing resources of the control system 80 be centralized; to the contrary, processing may be distributed amongst a number of processors that might, for example, be integrated within the various other (sub) systems within the overall moulding system 100.

Various features of the mould 15 are also shown in FIG. 2. In particular, the mould 15 is shown as having several internal surfaces 40 that together define a cavity 36 of the mould 15. The mould 15 also comprises a plurality of passageways 38 that provide fluid communication between the cavity 36 and an exterior of the mould. In certain examples, such as that shown in FIG. 2, the cavity 36 is free from a net or mesh; hence (or otherwise) the internal surfaces 40 that define the cavity 36 are generally smooth.

As may also be seen, in the particular example shown in FIG. 2, the mould 15 is formed from two separate half-moulds, similarly to the mould 15 shown in FIG. 1. However, this is by no means essential and in other examples the mould 15 could be formed of three, four etc. parts.

FIG. 2 further shows the arrangement of the negative pressure source 70 within the system 100. The negative pressure source 70 is, in general, configured to apply negative pressure to the exterior of the mould 15 and may, for example, comprise a vacuum pump. The negative pressure applied by the negative pressure source 70 to the exterior of the mould 15 may suction fibre suspension into the cavity 36 and onto the internal surfaces 40 of the mould 15. In addition, such negative pressure may draw liquid (such as water) out of the fibre suspension, through the passageways 38 of the mould 15, once the fibre suspension is deposited on the internal surfaces 40 of the cavity 36. Such expulsion of liquid from the fibre suspension may, for example, produce a wet precursor or embryo (which may itself be considered a moulded receptacle) that can be further moulded in another mould to produce a further-moulded receptacle, as described above in relation to FIG. 1.

In some examples, the negative pressures applied by negative pressure source 70 may be negative gas pressures. Such negative gas pressures may, for instance, be negative air pressures, in particular where moulding of the receptacle 22 using the mould 15 is carried out in air (and thus air is present in the cavity 36 during the first and second deposition periods and the pressure build-up period). However, in other examples such negative gas pressures may not be negative air pressures, for instance where the mould is arranged in a controlled atmosphere during the first and second deposition periods and the pressure build-up period.

Various exemplary features of the fibre suspension supply system 50 are also shown in FIG. 2. These specific features are not considered critical to the overall functioning of receptacle moulding system 100, given that (as those skilled in the art will appreciate) the fibre suspension supply system 50 may be constructed in a wide variety of ways in order to supply fibre suspension(s) to the cavity 36 of the mould 15. For example, fibre suspension supply system 50 may deposit fibre suspension(s) within the cavity 36 of the mould 15 by spraying fibre suspension(s) within the cavity 36, by pouring fibre suspension(s) into the cavity 36, or by dipping the mould 15 into fibre suspension(s). As will be appreciated, different constructions of the fibre suspension supply system 50 will be suitable for different constructions of the mould 15 (and vice versa).

Nevertheless, in the specific example shown in FIG. 2, the exemplary fibre suspension supply system 50 comprises a tank 56 which temporarily contains the fibre suspension 52 before it is introduced into the mould 15. The fibre suspension supply system 50 may, for example, be used along with the mixing station 13 of FIG. 1, or the mixing capabilities of the mixing station 13 could be performed by the fibre suspension supply system 50 itself. The fibre suspension supply system 50 of this example also comprises a line 54 along which the fibre suspension 52 can flow from the tank 56 and into the mould 15. The line 54 may be flexible in some examples.

As shown in FIG. 2, part-way along the line 54, is a controllable valve 55, whose operation is governed by the control system 80 (as part of the control system's control of the operation of the fibre suspension supply system 50), and which is configured to restrict the flow of fibre suspension to the cavity 36 of the mould 15, based on control signals/data received from the control system 80. This may be considered an exemplary construction of the fibre suspension supply system 50 that enables deposition of fibre suspension(s) within the cavity of the mould 15 to be restricted.

As may also be seen from FIG. 2, the fibre suspension supply system 50 of the particular example shown additionally comprises an arm 58 and a connecting portion 60. The line 54 runs through the arm 58 and into the connecting portion 60. The fibre suspension 52 exits the fibre suspension application system 50 and enters the mould 15 via the connecting portion 60 and an opening 42 in the mould 15 that opens into the cavity 36. In some examples, the connecting portion 60 is shaped to cooperate with the top of the mould 15 and/or a block 14 which contains the mould. In a particular example, the arm 58 is static, and the mould 15 is moved into place under the connecting portion 60. In another example, the arm 58 can be moved (by a human operator, or another piece of machinery) so that the connecting portion 60 can be connected to the mould 15. In a further example, the arm 58 is robotic (that is, it can move itself into the desired location).

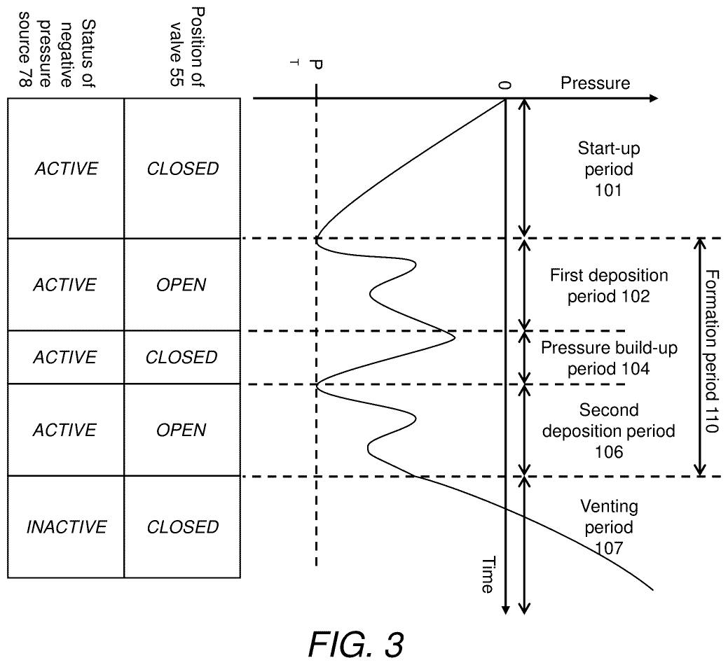

Reference is now directed to FIG. 3, which is a schematic diagram that illustrates the operation of the receptacle moulding system 100, under the control of control system 80, to mould a receptacle. At the top of FIG. 3 is shown a graph of the pressure, as measured at the external surface of the mould 15, during various time periods of the moulding operation. Below the graph is shown, for the various time periods of the moulding operation: the position of the valve 55 of the fibre suspension supply system 50; and the status of the negative pressure source 70 (specifically, whether the negative pressure source 70 is active, i.e. is applying negative pressure to the exterior of the mould 15, or is inactive, i.e. is not applying negative pressure to the exterior of the mould 15).

In general, in the moulding operation shown in FIG. 3, fibre suspension is deposited during two deposition periods—a first deposition period 102 and a second deposition period 106—that are separated by an intervening pressure build-up period 104.

Attention is directed firstly to the first deposition period 102 shown in FIG. 3. As may be seen, during this period, the valve 55 is in the open position and thus fibre suspension is deposited by the fibre suspension supply system 50 within the cavity 36 of the mould 15. In addition, in the particular example shown, the negative pressure source 70 is active, so that a negative pressure is applied to the exterior of mould 15. This negative pressure may cause the fibre suspension deposited within the cavity 36 to be suctioned onto the internal surfaces 40 of the mould 15.

In addition, such negative pressure may draw liquid (such as water) out of the fibre suspension, through the passageways 38 of the mould 15. The liquid removed from the fibre suspension/mould 15 may be measured by a liquid measurement system 74 that forms a further part of some examples of system 100. The liquid measurement system 74 may, for example, may comprise the weight scale platform and tank 17 depicted in FIG. 1, though this is by no means essential. Regardless of the specific construction, the liquid measurement system 74 may be communicatively coupled to the control system and/or other components of the system 100 so that actions can be stopped or performed or altered when the measured weight/volume reaches a particular threshold amount. In particular, the fibre suspension supply system 50 may be instructed to cease/stop the deposition of fibre suspension within the cavity 36 when the liquid measurement system 74 determines that the weight or volume of the liquid 76 has reached a predetermined amount. Hence, in some examples, the first deposition period 102 may end when the liquid measurement system 74 determines that the weight or volume of the liquid 76 removed from the mould 15 has reached a predetermined amount.

In other examples, the first deposition period 102 may end after a predetermined period of time. This period of time could, for example, correspond to a specific amount of fibre suspension being deposited, assuming typical functioning of the fibre suspension supply system 50.

In still other examples, the first deposition period 102 may end when the pressure as measured at the mould (for example at the exterior surface thereof, as depicted in FIG. 3, or within the cavity 36) rises above a predetermined negative value. This value may, for example, indicate that fibre suspension is no longer being suctioned against the internal surfaces 40 of the cavity 36 with sufficient force. Such a rise in pressure is apparent from FIG. 3: as time progresses during the first deposition period 102, and thus an increasing amount of fibre suspension is deposited within the cavity 36, the pressure at the exterior of the mould 15 increases (i.e. becomes less negative). The inventors believe that, once the pressure rises above a certain level, fibre suspension will undergo laminar, rather than turbulent flow, which may lead to less even deposition of the fibre suspension over the internal surfaces 40 of the cavity 36.

Attention is directed next to the pressure build-up period 104 shown in FIG. 3. As may be seen, during this period, valve 55 is in the closed position and thus deposition of fibre suspension within the cavity 36 of the mould 15 is substantially prevented. In addition, in the particular example shown, the negative pressure source 70 is active, so that a negative pressure is applied to the exterior of mould 15. The application of negative pressure to the exterior of the mould 15 in combination with the restriction of the deposition of fibre suspension leads to the build-up of negative pressure within the cavity 36, in advance of the second deposition period 106. This build-up of negative pressure within the cavity 36 can be inferred from the graph of the pressure at the exterior of the mould shown in FIG. 3. As may be seen from FIG. 3, as time progresses during the pressure build-up period 104, the pressure at the exterior of the mould becomes increasingly negative.

In some examples, the pressure build-up period 104 may end (and/or the second deposition period 106 may begin) when the pressure as measured at the mould (for example at the exterior surface thereof, as depicted in FIG. 3, or within the cavity 36) falls to below a predetermined negative value. This trigger value for the pressure (labelled as Pr in FIG. 3) may, for example, indicate that any fibre suspension that is then deposited within the cavity 36 will be suctioned against the internal surfaces 40 with sufficient force. This force may, for instance, tend to cause the fibre suspension to undergo turbulent, rather than laminar flow, leading to relatively even deposition of the fibre suspension over the internal surfaces 40 of the cavity 36. In addition, or instead, the trigger value (PT) may be the same as the value of the pressure at the beginning of the first deposition period 102, so that deposition occurs in relatively similar environments in the first and second deposition periods 102, 106.

In other examples, the pressure build-up period 104 may end (and/or the second deposition period 106 may begin) after a predetermined period of time. This period of time could, for example, correspond to a specific negative pressure being attained within the cavity 36, assuming typical functioning of the system 100, including the negative pressure source 70.

Attention is now directed to the second deposition period 106 shown in FIG. 3. As may be seen, during this period, valve 55 is in the open position and thus fibre suspension is deposited by the fibre suspension supply system 50 within the cavity 36 of the mould 15. Because a negative pressure of increasing magnitude was generated within the cavity 36 during the pressure build-up period 104, when fibre suspension is then deposited during the second deposition period 106, the fibre suspension will tend to preferentially accumulate at locations within the cavity 36 where less of (or none of) the fibre suspension deposited in the first deposition period 102 is present. Consequently, the fibre suspension deposited during the second deposition period 106, in combination with the fibre suspension deposited during the first deposition period 102, may together provide a deposited fibre layer that better covers the internal surfaces 40 that define the cavity 36 and/or that has a relatively uniform thickness.

It may also be noted that, in the particular example shown, the negative pressure source 70 is active during the second deposition period 106, so that a negative pressure is applied to the exterior of mould 15. This negative pressure may cause the fibre suspension deposited within the cavity 36 during the second deposition period 106 to be suctioned onto the fibre-containing layer deposited during the first deposition period 102 and the internal surfaces 40 of the mould 15. In addition, such negative pressure may draw liquid (such as water) out of the fibre suspension, through the passageways 38 of the mould 15.

As mentioned above, the liquid removed from the fibre suspension/mould 15 may be measured by a liquid measurement system 74 that, in some examples, forms a further part of the overall moulding system 100. In such examples, the first deposition period 102 may, for example, end when the liquid measurement system 74 determines that the weight or volume of the liquid 76 removed from the mould 15 has reached a predetermined amount.

In other examples, the second deposition period 106 may end after a predetermined period of time. This period of time could, for example, correspond to a specific amount of fibre suspension being deposited, assuming typical functioning of the fibre suspension supply system 50.

More generally, by suitable control of the operation of fibre suspension supply system 50, specific volumes of fibre suspension can be deposited within the cavity 36 during the first and second deposition periods 102, 106. For example, the fibre suspension supply system 50 may be controlled to deposit fibre suspension for a specific length of time and/or at a specific rate. The system 100 can therefore be configured, in some examples, to control the fibre suspension supply system 50 so as to deposit equal volumes of fibre suspension during the first and second deposition periods 102, 106, and, in other examples, to control the fibre suspension supply system 50 so as to deposit different volumes of fibre suspension during the first and second deposition periods 102, 106.

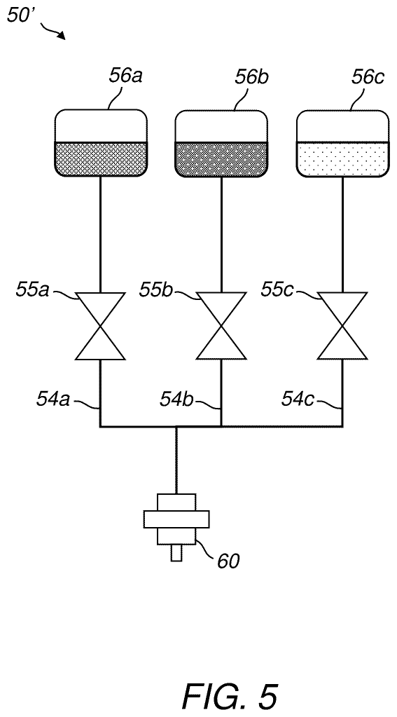

Furthermore, although the fibre suspension supply system 50 in the particular example shown in FIG. 2 is capable of supplying only a single type of fibre suspension (having only a single tank 56), it will be appreciated that, in other examples, the fibre suspension supply system 50 can be configured to supply plural different types of fibre suspension. For example, the fibre suspension supply system 50 might comprise plural tanks 56, lines 54 and valves 55 for supplying plural types of fibre suspension, as is the case in the further example of a fibre suspension supply system 50′ shown in FIG. 5, which will be described in further detail below. With a fibre suspension supply system 50 that is configured to supply plural different types of fibre suspension, respective different fibre suspensions may be deposited in the cavity 36 during the first and second deposition periods 102, 106.

In particular, it is envisaged that an average fibre length of the fibre suspension deposited in the first deposition period 102 may, in some examples, be different than an average fibre length of the fibre suspension deposited in the second deposition period 106. Without wishing to be bound by the theory, it is thought that that the characteristic average fibre length of a fibre suspension may impact the smoothness of the deposited layer of fibres. Suitable selection of the average fibre length for the fibre suspensions may therefore assist in providing a fibre layer with appropriate characteristics. As an example, a smaller average fibre length for the fibre suspension deposited in the first period 102 may provide a receptacle with a relatively smooth exterior surface.

Alternatively, or in addition, a freeness of the fibre suspension deposited in the first period 102 may be different than a freeness of the fibre suspension deposited in the second period 106. Without wishing to be bound by the theory, it is thought that that the freeness of a fibre suspension may impact how evenly fibres are distributed within the cavity 36. Suitable selection of the freeness for the fibre suspensions deposited in the first and second periods 102, 106 may therefore assist in providing a fibre layer with appropriate characteristics. As an example, a higher freeness may allow the fibre suspension deposited in the first period 102 to achieve a relatively even initial distribution of fibres within the cavity.

While in the particular example illustrated in FIG. 3 the system substantially prevents deposition of fibre suspension within the cavity 36 of the mould 15 during the pressure build-up period 104, in other examples the system 100 may more generally be configured so as to restrict—but not prevent—such deposition during that period. In the system shown in FIG. 3, this might be accomplished by moving the valve 55 to a more closed (but not completely closed) position for the pressure build-up period 104. In this more closed position, the rate of introduction of fibre suspension (e.g. the average or maximum rate) may be relatively lower than the deposition rate (e.g. the maximum deposition rate) during the first deposition period 102 and/or lower than the deposition rate (e.g. the maximum deposition rate) during the second deposition period 106. For example, it may be less than 20% of the deposition rate (e.g. the maximum deposition rate) during the first deposition period 102 and less than 20% of the deposition rate (e.g. the maximum deposition rate) during the second deposition period 106, or it may be less than 10% of the deposition rate (e.g. the maximum deposition rate) during the first deposition period 102 and/or less than 10% of the deposition rate (e.g. the maximum deposition rate) during the second deposition period 106.

More generally, it should be noted that it is by no means essential that the system 100 uses a valve to restrict/prevent deposition of fibre suspension within the cavity 36 of the mould 15. In other examples, a flow diverter could divert a variable amount of fibre suspension for recirculation, with the remainder of the fibre suspension being deposited within the cavity 36 of the mould.

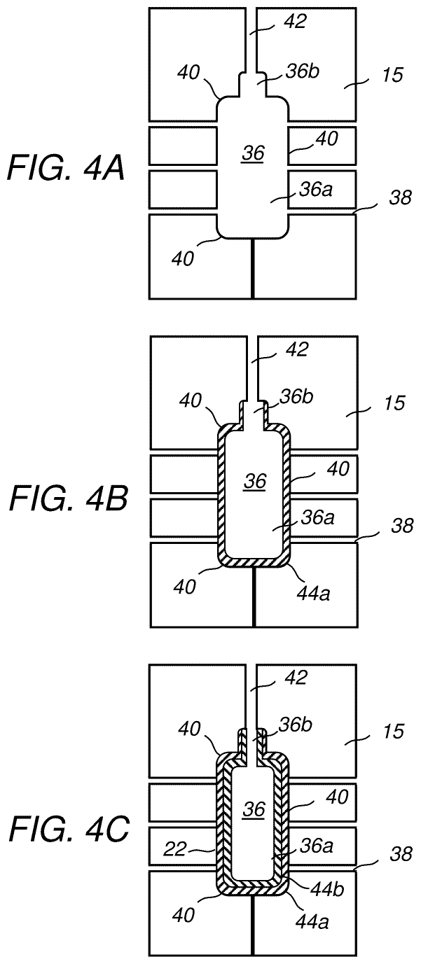

Attention is now directed to FIGS. 4A-4C, which are schematic diagrams showing the mould 15 at respective points in time during the moulding operation described above with reference to FIG. 3.

FIG. 4A shows the mould 15 prior to the first deposition period 102 and hence no fibre suspension is present within the cavity 36 of the mould 15. FIG. 4B shows the mould 15 after the first deposition period 102, but prior to the second deposition period 106. As may be seen, the fibre suspension deposited during the first deposition period 102 has formed a first layer 44a. FIG. 4C then shows the mould 15 after the second deposition period 106 and, as may be seen, the fibre suspension deposited during the second deposition period 106 has formed a second layer 44b.

It will be noted that, in the particular example shown, the second layer 44b covers the majority of, or the entirety of, the first layer 44a. However, this is by no means essential and in other examples, the second layer 44b might cover or overlap the first layer 44a only partially, or may not overlap the first layer 44a at all. Similarly, while in the particular example shown the first layer 44a covers the majority of, or the entirety of the internal surfaces 40 that define the cavity 36, this is by no means essential and in other examples, the first layer 44a might cover the internal surfaces 40 only partially, or not at all. Moreover, in examples where fibre suspension is selectively deposited so that the first layer 44a only partially covers the internal surfaces 40 of the cavity 36, the negative pressure that is generated within the cavity during the pressure build-up period 104 may tend to encourage the second layer 44b to be preferentially formed over part(s) of the internal surfaces 40 that are not covered by the first layer 44a.

Returning now to FIG. 3, in some examples, the control system 80 may cause the negative pressure source 70 to remain in an active state for the whole of a formation period 110, which comprises the first deposition period 102, the pressure build-up period 104 and the second deposition period 106. Consequently, throughout the formation period 110, the negative pressure source 70 applies negative pressure to the exterior of the mould 15. In such examples, operation of the system 100 may be simplified. In specific examples, the negative pressure generated/applied by the negative pressure source 70 may remain substantially constant throughout the formation period 110.

It should also be noted that, while in the particular example shown in FIG. 3 the formation period 110 (and the moulding operation more generally) comprises only two deposition periods, in other embodiments the formation period 110 (and the overall moulding operation) might comprise additional deposition periods (i.e. a third, fourth, fifth etc. deposition period). In such embodiments, the formation period 110 (and the overall moulding operation) may, for example, comprise two or more pressure build-up periods, each of which timewise separates one deposition period for an immediately succeeding deposition period.

Again referring to FIG. 3, in some examples, the control system 80 may additionally be configured to control the system 100 so as to operate in a start-up period 101, which is prior to the first deposition period 102. During this start-up period 101, the control system prevents (or perhaps limits to a very low level) the deposition of fibre suspension within the cavity 36 of the mould 15. In the embodiment illustrated in FIG. 3, this is accomplished by moving the valve 55 to a closed position. In addition, the control system 80 controls the negative pressure source 70 so that it applies negative pressure to the exterior of the mould 15. As a result, a negative pressure of increasing magnitude is generated within the cavity 36 of the mould 15 during the start-up period 101, similarly to the process during the pressure build-up period 104. Consequently, when the first volume of fibre suspension is then deposited, it may be expected to be suctioned against the internal surfaces 40 of the mould 15 with suitable force.

On the other hand (and regardless of whether the system operates in a start-up period 101), it should be understood that it is not essential that the negative pressure source 70 applies negative pressure to the exterior of the mould 15 during the first deposition period 102. In particular, it should be understood that the application of negative pressure to the exterior of the mould 15 is not essential to the introduction of fibre suspension into the mould 15. Various approaches for introducing fibre suspension into the mould 15 may be employed that do not rely on suctioning the fibre suspension against the internal surfaces 40 of the mould 15 using the negative pressure source 70. Nevertheless, given that the negative pressure source 70 applies negative pressure to the exterior of the mould 15 during the second deposition period 106, operation of the system 100 may be simplified where the system functions in generally the same way during the first deposition period 102.

In some examples, the control system 80 may be configured to control the system 100 so as to operate in a venting period 107, which is after the second deposition period 106. During this venting period 107, the cavity 36 of the mould 15 is vented, for example by opening the cavity 36 to the atmosphere via an opening or passage. As illustrated in FIG. 3, this leads to a rapid rise in the pressure at the exterior of the mould 15 and, as will be appreciated, leads to rapid rise in the pressure within the cavity 36 of the mould 15, also. As also illustrated in FIG. 3, during the venting period 107, the control system 80 may cause the negative pressure source 70 to become inactive so that it does not apply negative pressure to the exterior of the mould 15.

Where the cavity 36 is opened to the atmosphere during the venting period 107, the pressure within the cavity 36 may be allowed to continue to rise until it equalizes with atmospheric pressure. This may facilitate the disconnection of the fibre suspension supply system 50 from the mould 15, particularly in embodiments where the connecting portion 60 of the fibre suspension supply system 50 is configured to form a fluid-tight seal with the mould 15 when engaged therewith (such as, for example, embodiments where the connecting portion 60 comprises a bung). Disconnection of the fibre suspension supply system 50 from the mould 15 may, for example, allow a further system to engage with the mould, such as a system for removing further suspending liquid (e.g. water) from the receptacle 22, and/or for consolidating the three-dimensional shape of the receptacle. Such a system might, for example, comprise an impermeable inflation element 19, e.g., a collapsible bladder, as shown in FIG. 1.

Particularly (but not exclusively) where the fibre suspension supply system 50 is disconnected from the mould 15 during or after the venting period 107, the control system 80 may prevent (or perhaps limit to a very low level) the deposition of fibre suspension within the cavity 36 of the mould 15 during the venting period 107. In the embodiment illustrated in FIG. 3, this is accomplished by moving the valve 55 to a closed position.

Reference is now directed to FIG. 5, which is a schematic diagram of a fibre suspension supply system 50′ forming part of a receptacle moulding system 100 according to a further example embodiment of the invention. With the exception of the fibre suspension supply system 50′, the components of the system 100 are generally as described above with reference to FIGS. 3 and 4. For this reason, FIG. 5 illustrates only the features of the fibre suspension supply system 50′.

The fibre suspension supply system 50′ shown in FIG. 5 is operable to supply a fibre suspension whose composition is determined based on control signals/data received from the control system 80. In the particular example shown, the fibre suspension supply system 50′ includes several tanks 56a, 56b and 56c, each containing a different composition. Each tank is connected by a separate line 54a-54c to a single connecting portion 60 for the fibre suspension supply system 50′.

In a particular example, tanks 56a and 56b may contain respective, different fibre suspensions, whereas tank 56c may contain water. More particularly, the fibre suspensions in tanks 56a and 56b may, for instance, have respective, different average fibre lengths. Thus, by mixing the two fibre suspensions in specific proportions (e.g. determined based on control signals/data received from the control system 80), a fibre suspension having a desired average fibre length can be achieved. Furthermore, by adding a specific amount of water from tank 56c (e.g. determined based on control signals/data received from the control system 80), a desired freeness for the fibre suspension can be achieved. It will, however, be appreciated that this is merely one example of an approach that allows the composition of a fibre suspension to be controlled. In other examples, more or fewer tanks could be provided and other compositions could be provided within each such tank.

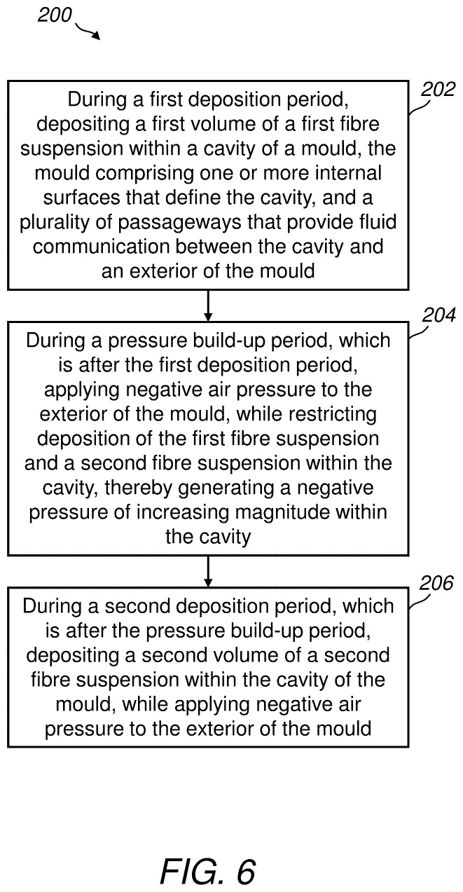

Reference is now directed to FIG. 6, which is a flow diagram illustrating a method 200 for manufacturing a moulded receptacle according to a further aspect of the invention. The method 200 may, for example, be implemented using a receptacle moulding system 100 according to one of the examples described above with reference to FIGS. 2-5.

As shown at block 202, the method comprises, during a first deposition period, depositing a first volume of a first fibre suspension within a cavity 36 of a mould 15. As illustrated in FIG. 2, for example, the mould 15 comprises one or more internal surfaces 40 that define the cavity 36, and a plurality of passageways 38 that provide fluid communication between the cavity 36 and an exterior of the mould 15.

At block 204, the method 200 comprises, during a pressure build-up period 104, which is after the first deposition period 102, applying negative pressure to the exterior of the mould 15, while restricting deposition within the cavity 36 of the first fibre suspension and a second fibre suspension (which is deposited during a second deposition period, discussed below). As a result of the application of negative pressure to the exterior of the mould 15, in combination with the restriction of deposition of the first and second fibre suspensions within the cavity 36, a negative pressure of increasing magnitude is generated within the cavity 36.

At block 206, the method 200 comprises, during a second deposition period 106, which is after the pressure build-up period 104, depositing a second volume of a second fibre suspension within the cavity 36 of the mould 15, while applying negative pressure to the exterior of the mould.

Because a negative pressure of increasing magnitude is generated within the cavity 36 during the pressure build-up period 104, when the second volume of second fibre suspension is then deposited, the second fibre suspension may preferentially accumulate at locations within the cavity where less of (or none of) the first fibre suspension is present. Consequently, a deposited fibre layer that better covers the internal surfaces defining the cavity and/or has a relatively uniform thickness may be provided by the thus-deposited second volume of the second fibre suspension in combination with the first volume of the first fibre suspension.

It should be noted that the first and second fibre suspensions need not be different; in some examples, they may be the same. Furthermore, the first and second volumes need not be different and may, in some examples, be the same.

As mentioned above, the method 200 may, for example, be implemented using a receptacle moulding system 100 according to one of the examples described above with reference to FIGS. 2-5. Moreover, examples of the method 200 may incorporate features of the first deposition period 102, pressure build-up period 104 and second deposition period 106 that are described in the context of one of the examples of the receptacle moulding system 100.

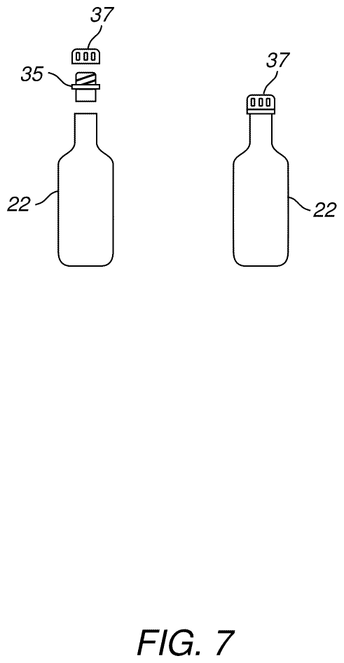

Reference is now directed to FIG. 7, which is a side view of a receptacle 22 according to a still further aspect of the invention in assembled and disassembled states. In the example shown, the receptacle is a bottle 22.

The receptacle 22 is obtainable or obtained from a fabrication method that comprises any of the above-described methods for manufacturing a moulded receptacle, such as the method 200 described above with reference to FIG. 6.

The fabrication method may, in some examples, comprise at least one process in addition to the above-described methods for manufacturing a moulded receptacle. For example, the at least one additional process may comprise further moulding a receptacle as produced by one of the above-described methods for manufacturing a moulded receptacle (such as method 200 illustrated in FIG. 6) to produce a further-moulded receptacle.

As another example, the at least one additional process may comprise coating and drying a receptacle as produced by one of the above-described methods for manufacturing a moulded receptacle (or a further-moulded receptacle produced by further moulding such a moulded receptacle) to produce a coated receptacle. As described above with reference to FIG. 1, as part of a coating process, a spray lance 31 may be inserted into a moulded receptacle 22 so as to apply one or more surface coatings to internal walls of the moulded receptacle 22. Alternatively, a moulded receptacle 22 can instead be filled with a liquid that coats the internal walls of the moulded receptacle 22.

In a still further example, the at least one additional process may comprise applying a closure to such a receptacle, further-moulded receptacle or coated receptacle. For example, a neck fitment 35 may be affixed, as is the case with the receptacle shown in FIG. 7. The neck fitment 35 is shown removed from the receptacle 22 in the partially disassembled view on the left of FIG. 7. Such a neck fitment 35 may be configured to couple with a corresponding cap 37, e.g. by means of a screw thread on one or both of the neck fitment 35 and cap 37. The cap 37 is shown coupled with the neck fitment 35 in the assembled view of the receptacle on the right of FIG. 7.

Example embodiments of the present invention have been discussed, with reference to the examples illustrated. However, it will be appreciated that variations and modifications may be made without departing from the scope of the invention as defined by the appended claims.

What is claimed is:

1. A receptacle moulding system for moulding a receptacle from a fibre suspension, the system comprising:
a mould comprising one or more internal surfaces that define a cavity, and a plurality of passageways that provide fluid communication between the cavity and an exterior of the mould;
a fibre suspension supply system;
a negative pressure source, configured to apply negative pressure to the exterior of the mould; and
a control system, configured to control the fibre suspension supply system and the negative pressure source such that:
during a first deposition period, a first volume of a first fibre suspension is deposited by the fibre suspension supply system within the cavity of the mould;
during a second deposition period, a second volume of a second fibre suspension is deposited by the fibre suspension supply system within the cavity of the mould, while the negative pressure source applies negative pressure to the exterior of the mould; and
during a pressure build-up period, which is after the first deposition period and before the second deposition period, the negative pressure source applies negative pressure to the exterior of the mould, while the fibre suspension supply system restricts deposition of the first and second fibre suspensions within the cavity, thereby generating a negative pressure of increasing magnitude within the cavity.

2. The system of claim 1, configured so that, as a result of the negative pressure source applying negative pressure to the exterior of the mould during the depositing of the second volume of the second fibre suspension, turbulent flow of the second volume of the second fibre suspension occurs within the cavity.

3. The system of claim 1, further comprising a pressure sensor configured to measure pressure at the mould, and
wherein the control system is configured to cause the depositing of the second volume of the second fibre suspension, by the fibre suspension supply system, once a pressure value, as measured by the pressure sensor, falls below a predetermined negative threshold value.

4. The system of claim 1, wherein the control system is configured to control the fibre suspension supply system such that, throughout the pressure build-up period, no deposition of any fibre suspension takes place in the cavity.

5. The system of claim 1, wherein the control system is configured to control the fibre suspension supply system such that:
during the first deposition period, the first fibre suspension is introduced into the cavity at a first rate and, during the second deposition period, the second fibre suspension is introduced into the cavity at a second rate; and
during the pressure build-up period, the fibre suspension supply system restricts deposition of the first and second fibre suspensions within the cavity such that a rate of introduction of fibre suspension into the cavity is less than the first rate and/or less than the second rate.

6. The system of claim 5, wherein the rate of introduction of fibre suspension during the pressure build-up period is less than 10% of the first rate and/or less than 10% of the second rate.

7. The system of claim 1, wherein the depositing of the first volume of the first fibre suspension leads to the formation of a first fibre-containing layer on the internal surfaces defining the cavity, and the depositing of the second volume of the second fibre suspension leads to the formation of a second fibre-containing layer, wherein the second layer at least partially covers the first layer.

8. The system of claim 1, wherein the control system is configured to control the fibre suspension supply system and the negative pressure source such that, during the depositing of the first volume of the fibre suspension, negative pressure is applied to the exterior of the mould.

9. The system of claim 1, wherein the control system is configured to control the negative pressure source such that, throughout a formation period, which comprises the first deposition period, the second deposition period and the pressure build-up period, the negative pressure source applies negative pressure to the exterior of the mould.

10. A method for manufacturing a moulded receptacle, the method comprising:
during a first deposition period, depositing a first volume of a first fibre suspension within a cavity of a mould, the mould comprising one or more internal surfaces that define the cavity, and a plurality of passageways that provide fluid communication between the cavity and an exterior of the mould;
during a second deposition period, depositing a second volume of a second fibre suspension within the cavity of the mould, while applying negative pressure to the exterior of the mould; and
during a pressure build-up period, which is after the first deposition period and before the second deposition period, applying negative pressure to the exterior of the mould, while restricting deposition of the first and second fibre suspensions within the cavity, thereby generating a negative pressure of increasing magnitude within the cavity.

11. The method of claim 10, wherein the applying of negative pressure to the exterior of the mould during the depositing of the second volume of the second fibre suspension causes turbulent flow of the second volume of the second fibre suspension.

12. The method of claim 10, wherein the depositing of the first volume of the first fibre suspension leads to the formation of a first fibre-containing layer on the internal surfaces defining the cavity, and the depositing of the second volume of the second fibre suspension leads to the formation of a second fibre-containing layer, wherein the second layer at least partially covers the first layer.

13. The method of claim 10, wherein the first fibre suspension is substantially the same as the second fibre suspension.

14. The method of claim 10, wherein an average fibre length of the first fibre suspension is different than an average fibre length of the second fibre suspension.

15. The method of claim 14, wherein the average fibre length of the first fibre suspension is less than the average fibre length of the second fibre suspension.

16. The method of claim 10, wherein a freeness of the first fibre suspension is different than a freeness of the second fibre suspension.

17. The method of claim 16, wherein the freeness of the first fibre suspension is greater than the freeness of the second fibre suspension.

18. The method of claim 10, wherein the receptacle is a bottle.

19. The system of claim 1, wherein the receptacle is a bottle.

20. A receptacle produced by the process comprising:
during a first deposition period, depositing a first volume of a first fibre suspension within a cavity of a mould, the mould comprising one or more internal surfaces that define the cavity, and a plurality of passageways that provide fluid communication between the cavity and an exterior of the mould;
during a second deposition period, depositing a second volume of a second fibre suspension within the cavity of the mould, while applying negative pressure to the exterior of the mould; and
during a pressure build-up period, which is after the first deposition period and before the second deposition period, applying negative pressure to the exterior of the mould, while restricting deposition of the first and second fibre suspensions within the cavity, thereby generating a negative pressure of increasing magnitude within the cavity.
